(19) United States
(12) Patent Application Publication
(10) Pub. No.: US 2025/0347938 A1
(43) Pub. Date: Nov. 13, 2025

(54) OPTICAL DEVICES AND METHODS OF MANUFACTURE

(71) Applicant: Taiwan Semiconductor Manufacturing Co., Ltd., Hsinchu (TW)

(72) Inventors: Ming Lee, Taipei City (TW); Tien-Lin Shen, Taipei City (TW); Wei-Heng Lin, Taipei City (TW); Hsing-Kuo Hsia, Jhubei City (TW); Chen-Hua Yu, Hsinchu (TW)

(21) Appl. No.: 19/275,738

(22) Filed: Jul. 21, 2025

Related U.S. Application Data
(63) Continuation of application No. 18/402,065, filed on Jan. 2, 2024.
(60) Provisional application No. 63/501,477, filed on May 11, 2023.
(60) Provisional application No. 63/509,809, filed on Jun. 23, 2023.

(51) Int. Cl. G02F 1/017

(52) U.S. Cl. CPC G02F 1/017

(57) ABSTRACT

An optical device and method of manufacture is presented. In embodiments a method includes forming a first layer of optical material, patterning the first layer into a stair-step pattern, depositing a dielectric material onto the stair-step pattern, and forming a second layer of optical material over the dielectric material and at least partially within the stair-step pattern.

### PRIORITY CLAIM AND CROSS-REFERENCE

This application is a continuation of U.S. patent application Ser. No. 18/402,065, filed on Jan. 2, 2024, which application claims the benefit of U.S. Provisional Application No. 63/509,809, filed on Jun. 23, 2023, and U.S. Provisional Application No. 63/501,477, filed on May 11, 2023, which applications are hereby incorporated herein by reference.

### BACKGROUND

Electrical signaling and processing is one technique for signal transmission and processing. Optical signaling and processing have been used in increasingly more applications in recent years, particularly due to the use of optical fiber-related applications for signal transmission.

Optical signaling and processing are typically combined with electrical signaling and processing to provide full-fledged applications. For example, optical fibers may be used for long-range signal transmission, and electrical signals may be used for short-range signal transmission as well as processing and controlling. Accordingly, devices integrating long-range optical components and short-range electrical components are formed for the conversion between optical signals and electrical signals, as well as the processing of optical signals and electrical signals. Packages thus may include both optical (photonic) dies including optical devices and electronic dies including electronic devices.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1A-1B illustrate a substrate on insulator, in accordance with some embodiments.

FIGS. 2A-2B illustrate a patterning and doping of a first optical material, in accordance with some embodiments.

FIGS. 3A-3B illustrate a deposition of a first dielectric material, in accordance with some embodiments.

FIGS. 4A-4B illustrate a deposition of a second dielectric material, in accordance with some embodiments.

FIGS. 5A-5B illustrate a deposition of a second optical material, in accordance with some embodiments.

FIGS. 6A-6B illustrate a patterning and doping of the second optical material, in accordance with some embodiments.

FIGS. 7A-7B illustrate a deposition of a third dielectric material, in accordance with some embodiments.

FIGS. 8A-8B illustrate a patterning of the third dielectric material and the first dielectric material, in accordance with some embodiments.

FIGS. 9A-9B illustrate a formation of contacts, in accordance with some embodiments.

FIG. 10 illustrates a plan view of the optical device, in accordance with some embodiments.

FIG. 11 illustrates an embodiment wherein the first optical material has at least three thicknesses, in accordance with some embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Embodiments will now be described with respect to a particular embodiment in which a capacitor phase modulator has interleaved portions which provide better field overlap between a carrier accumulation region and an optical field in a 28 nanometer process node. The embodiments described herein, however, are intended to be illustrative and are not intended to limit the ideas presented to these precise embodiments. Rather, the ideas presented may be implemented in other devices, such as optical transceivers or on-chip optical interconnects. All such embodiments are fully intended to be included within the scope of the embodiments.

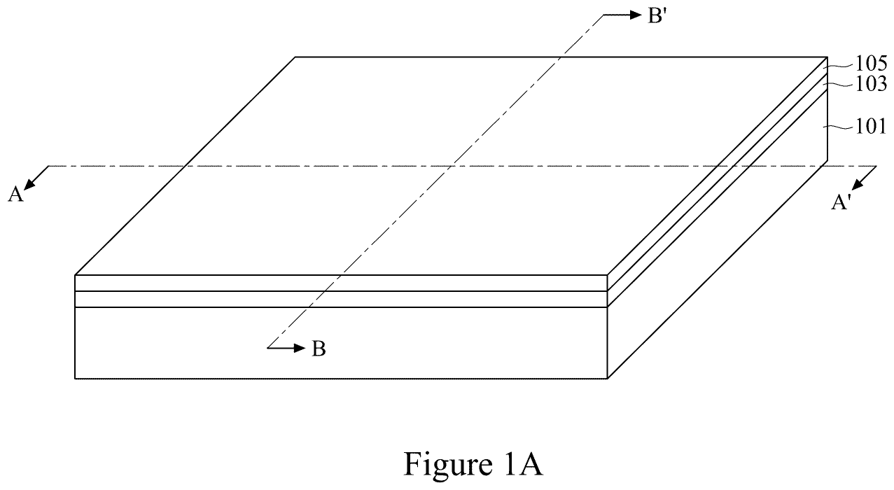

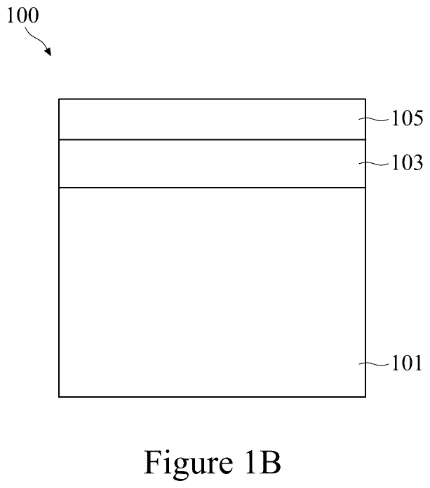

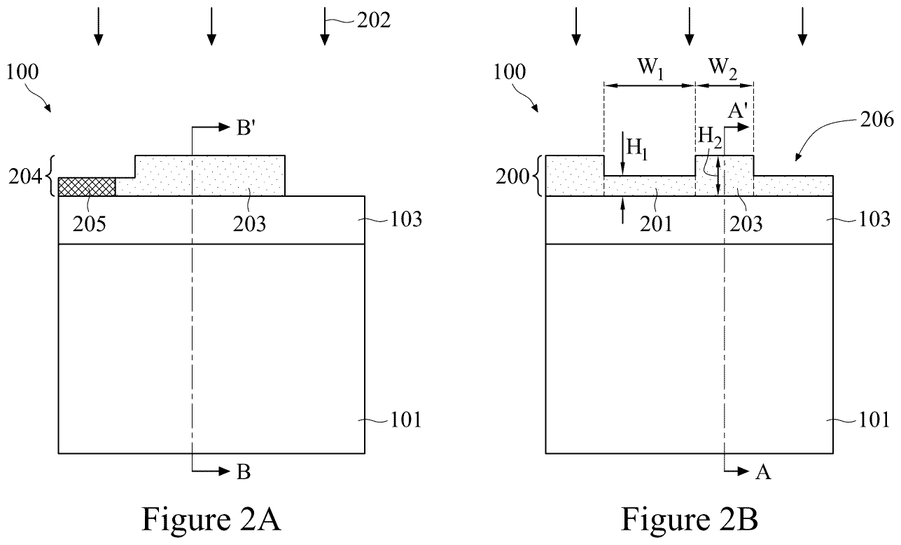

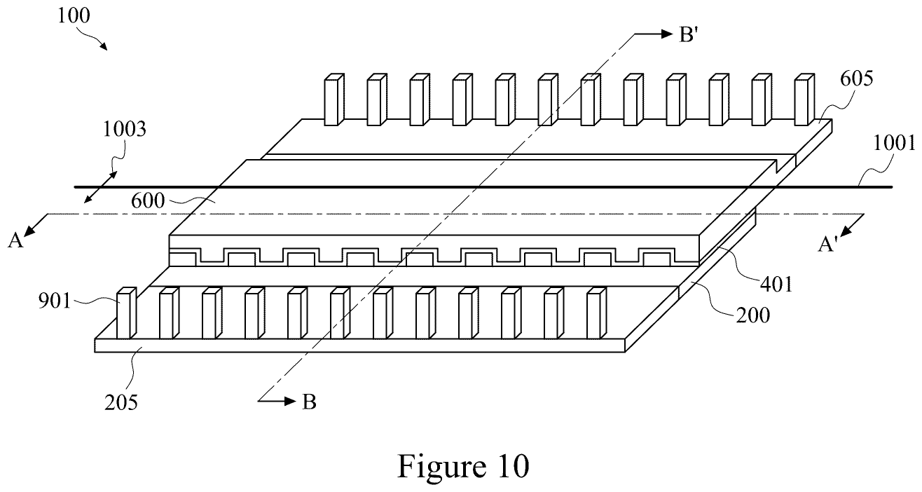

With reference now to FIGS. 1A-1B, there is illustrated an initial structure used to form a photonic electro-optical modulator 100 (seen in FIG. 10), such as a capacitor phase modulator, in accordance with some embodiments, with FIG. 1A illustrating a perspective view and FIG. 1B illustrating a cross-sectional view along line B-B′ in FIG. 1A. In the particular embodiment illustrated in FIGS. 1A-1B, the photonic electro-optical modulator 100 is part of a photonic integrated circuit (PIC) and comprises at this stage a first substrate 101, a first insulator layer 103, and a layer of material 105 for a first active layer 204 of first optical components (not separately illustrated in FIGS. 1A-1B but illustrated and discussed further below with respect to FIG. 2A). In an embodiment, at a beginning of the manufacturing process of the photonic electro-optical modulator 100, the first substrate 101, the first insulator layer 103, and the layer of material 105 for the first active layer 204 of first optical components may collectively be part of a silicon-on-insulator (SOI) substrate. Looking first at the first substrate 101, the first substrate 101 may be a semiconductor material such as silicon or germanium, a dielectric material such as glass, or any other suitable material that allows for structural support of overlying devices.

The first insulator layer 103 may be a dielectric layer that separates the first substrate 101 from the overlying first active layer 204 and can additionally, in some embodiments, serve as a portion of cladding material that surrounds the subsequently manufactured first optical components (discussed further below). In an embodiment the first insulator layer 103 may be silicon oxide, silicon nitride, germanium oxide, germanium nitride, combinations of these, or the like, formed using a method such as implantation (e.g., to form a buried oxide (BOX) layer) or else may be deposited onto the first substrate 101 using a deposition method such as chemical vapor deposition, atomic layer deposition, physical vapor deposition, combinations of these, or the like. However, any suitable material and method of manufacture may be used.

The material 105 for the first active layer 204 is initially (prior to patterning) a conformal layer of material that will be used to begin manufacturing the first active layer 204 of the first optical components. In an embodiment the material 105 for the first active layer 204 may be a translucent material that can be used as a core material for the desired first optical components, such as a semiconductor material such as silicon, germanium, silicon germanium, combinations of these, or the like, while in other embodiments the material 105 for the first active layer 204 may be a dielectric material such as silicon nitride or the like, although in other embodiments the material 105 for the first active layer 204 may be III-V materials, lithium niobate materials, or polymers. In embodiments in which the material 105 of the first active layer 204 is deposited, the material 105 for the first active layer 204 may be deposited using a method such as epitaxial growth, chemical vapor deposition, atomic layer deposition, physical vapor deposition, combinations of these, or the like. In other embodiments in which the first insulator layer 103 is formed using an implantation method, the material 105 of the first active layer 204 may initially be part of the first substrate 101 prior to the implantation process to form the first insulator layer 103. However, any suitable materials and methods of manufacture may be utilized to form the material 105 of the first active layer 204.

FIGS. 2A-2B illustrate a patterning and implantation of the material 105, wherein FIG. 2B illustrates a cross-sectional view of FIGS. 1A and 2A along line B-B′ and wherein FIG. 2A illustrates a cross-sectional view of FIGS. 1A and 2B along line A-A′. In an embodiment the material 105 for the first active layer 204 may be patterned into the desired shapes for the first active layer 204 of first optical components and in the particular embodiment illustrated in FIGS. 2A-2B, the desired shape for a portion of the photonic electro-optical modulator 100. In an embodiment the material 105 may be patterned to form recesses 206 using, e.g., one or more photolithographic masking and etching processes. However, any suitable method of patterning the material 105 may be utilized.

In the embodiment illustrated in FIGS. 2A-2B, the material 105 is patterned to form a first dopant region 200 that has a first region 201 and a second region 203 (separated in FIG. 2B by dashed lines that may or may not be present in the final product) that have different thicknesses so that the first region 201 and the second region 203 have a stair structure. For example, the first region 201 may be patterned to have a first width W₁ of between about 100 nm and about 400 nm and a first height H₁ of between about 70 nm and about 200 nm. However, any suitable dimensions may be utilized.

Looking next at the second region 203, the second region may be formed with a larger thickness than the first region 201. In an embodiment the second region 203 may be formed to have a second width W₂ of between about 100 nm and about 400 nm, such as about 500 nm, and a second height H₂ of between about 150 nm and about 300 nm. However, any suitable dimensions may be utilized.

Additionally, while FIG. 2B illustrates two first regions 201 and two second regions 203, this is intended to be illustrative and is not intended to be limiting upon the embodiments. Rather, any suitable number of the first regions 201 and the second regions 203 may be utilized. All such numbers are fully intended to be included within the scope of the embodiments.

Once the material 105 has been patterned, a first implantation process (represented in FIGS. 2A-2B by the arrows labeled 202) may be performed in order to implant first dopants into the first region 201, the second region 203, and a third region 205. In an embodiment the first implantation process 202 may be two or more implantations which implant first dopants within the first region 201, the second region 203 and the third region 205 which may be utilized along with second dopants (discussed further below) to form the photonic electro-optical modulator 100. As such, while the precise first dopant may be dependent at least in part on the design of the photonic electro-optical modulator 100, in some embodiments the first dopants may be a p-type dopant such as boron, gallium, or indium. However, any suitable dopants may be used.

In an embodiment the first dopants may be implanted into the first region 201 and the second region 203 using one of the implantations of the first implantation process 202, whereby ions of the desired first dopants are accelerated and directed towards the first region 201 and the second region 203. The ion implantation process may utilize an accelerator system to accelerate ions of the desired first dopant at a first dosage concentration. As such, while the precise dosage concentration utilized will depend at least in part on the first region 201 and the second region 203 and the first dopants used, in one embodiment the accelerator system may utilize an energy of between about 100 eV and about 600 eV along with a dosage concentration of about 1E13 atoms/cm² to about 1E15 atoms/cm². However, any suitable parameters may be utilized.

Additionally, the first dopants may be implanted perpendicular to the first region 201 and the second region 203 or else at, e.g., an angle of between about 0° and about 60°, from perpendicular to the first region 201 and the second region 203 and may be implanted at a temperature of between about −20° C. and about 100° C. However, any suitable parameters may be utilized.

In one particular embodiment the first dopants are implanted in order to form P+ regions within the patterned material 105. As such, the first dopants may have a concentration within the first region 201 and the second region 203 of between about 1e17 cm⁻³ and about 8e18 cm⁻³. However, any suitable concentration may be utilized.

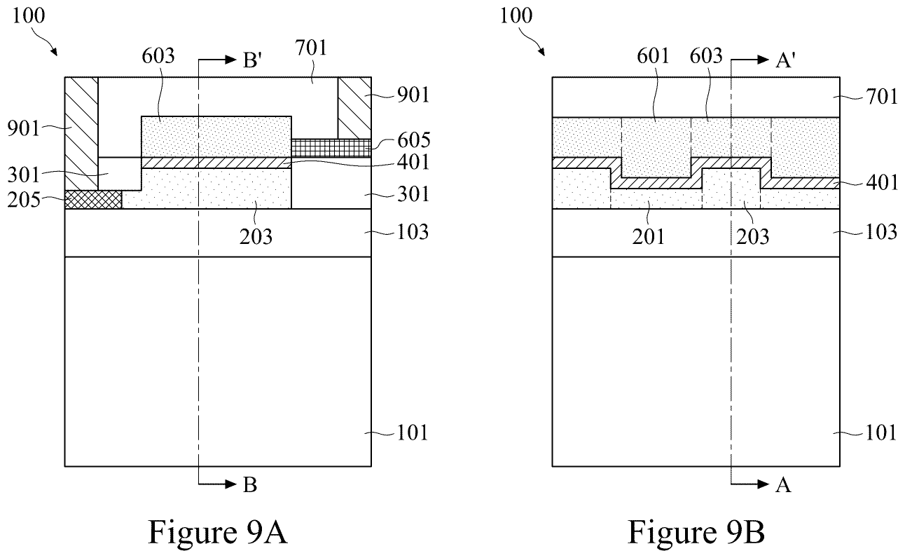

One of the implantations of the first implantation process 202 may also be used to implant the first dopants into the third region 205. In an embodiment the third region 205 will be utilized to provide a connection between the first region 201 and the second region 203 and, e.g., a contact 901 (not illustrated in FIGS. 2A-2B but illustrated and discussed further below with respect to FIG. 9A). In this embodiment the third region 205 may be a P++ region and, as such, comprises the first dopants at a concentration of between about 1e19 cm⁻³ and about 1e21 cm⁻³. However, any suitable concentrations may be utilized.

Additionally, the first implantation process 202 may be performed by any suitable number of implantations. For example, in one embodiment two or more separate implantations may be performed in order to implant the first dopants into the first region 201 and the second region 203 and the third region 205, or more than two implants may be utilized. In other embodiments, a single implant may be performed for the first region 201 and the second region 203 while a second implant is performed for the third region 205. Any suitable number of implants may be utilized, and all such implants are fully intended to be included within the scope of the embodiments.

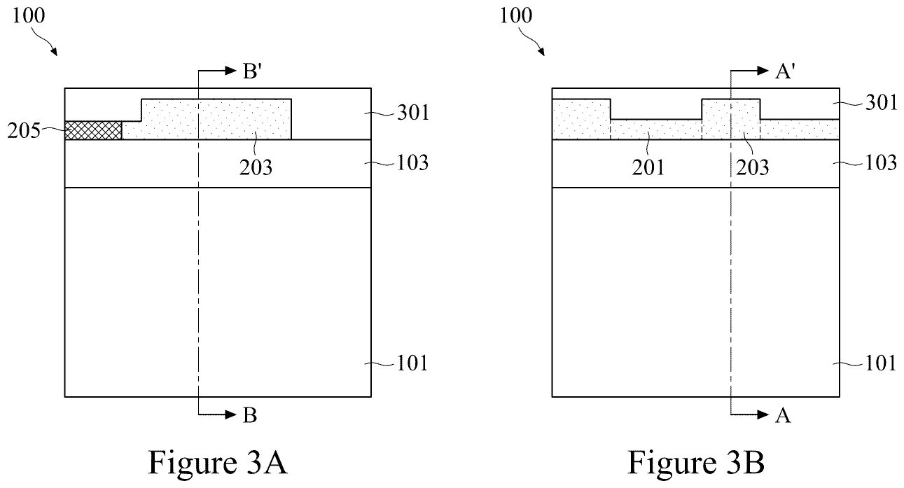

FIGS. 3A-3B illustrate a deposition of a first dielectric material 301 over the first region 201, the second region 203, and the third region 205, wherein FIG. 3B illustrates a cross-sectional view of FIGS. 1A and 3A along line B-B′ and wherein FIG. 3A illustrates a cross-sectional view of FIGS. 1A and 3B along line A-A′. In an embodiment the first dielectric material 301 may be a dielectric material such as silicon oxide, or other low-k dielectric material (k≤3.9) such as silicon oxynitride, combinations of these, or the like, deposited using a deposition process such as chemical vapor deposition, physical vapor deposition, atomic layer deposition, combinations of these, or the like. Once the first dielectric material 301 has been deposited, the first dielectric material 301 may be planarized using, e.g., a planarization process such as chemical mechanical planarization process. However, any suitable materials and processes may be utilized.

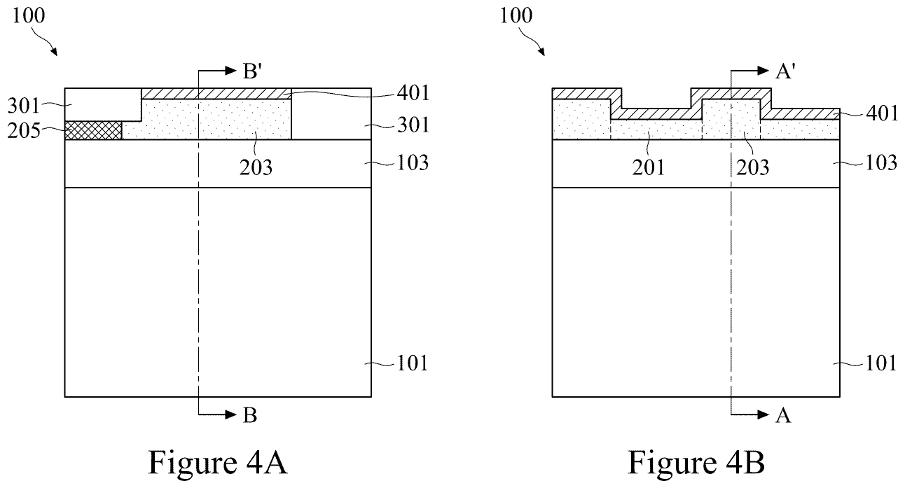

FIGS. 4A-4B illustrate a replacement of the first dielectric material 301 with a second dielectric material 401 over the first region 201 and the second region 203, wherein FIG. 4B illustrates a cross-sectional view of FIG. 4A along line B-B′ and wherein FIG. 4A illustrates a cross-sectional view of FIG. 4B along line A-A′. In an embodiment the replacement may be initiated by initially removing a portion of the first dielectric material 301 in order to expose the first region 201 and the second region 203. This removal may be performed using, for example, a photolithographic masking and etching process. However, any suitable method may be utilized.

Once the portion of the first dielectric material 301 has been removed, the second dielectric material 401 may be deposited on top surfaces and sidewalls of the first region 201 and the second region 203 (e.g., the P+ region). In an embodiment the second dielectric material 401 may be a high-k dielectric material (k>3.9) suitable for use as a gate oxide, and may be a material that has a k value greater than about 7.0, and may include a metal oxide or a silicate of Hf, Al, Zr, La, Mg, Ba, Ti, Pb, and combinations thereof using a deposition method such as ALD, CVD, Molecular-Beam Deposition (MBD), the like, or a combination thereof. The second dielectric material 401 may be deposited to a thickness of between about 2 nm and about 5 nm. However, any suitable material and any suitable method of deposition may be utilized.

In some embodiments the second dielectric material 401 is deposited using a conformal deposition process. As such, the second dielectric material 401 will take on the shape of the underlying layers such as the first region 201 and the second region 203. In such embodiments the second dielectric material 401 will also have the stair pattern that the first region 201 and the second region 203 have.

Once the second dielectric material 401 has been deposited, portions of the second dielectric material 401 over the first dielectric material 301 are removed. In an embodiment the portions of the second dielectric material 401 may be removed using a photolithographic masking and etching process, or else may be removed using a planarization process such as chemical mechanical process. Any suitable methods may be utilized.

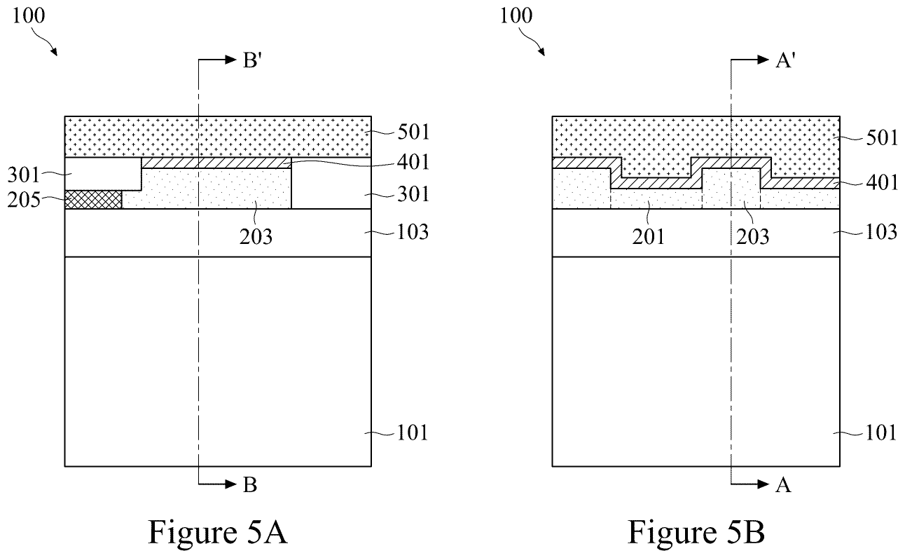

FIGS. 5A-5B illustrate deposition of a second material 501 over the first dielectric material 301 and the second dielectric material 401, wherein FIG. 5B illustrates a cross-sectional view of FIG. 5A along line B-B′ and wherein FIG. 5A illustrates a cross-sectional view of FIG. 5B along line A-A′. In an embodiment the second material 501 may a material that is similar to the material 105 (discussed above with respect to FIGS. 1A-1B). In a particular embodiment the first dielectric material 301 may be a material such as silicon (e.g., polysilicon) deposited using a deposition process such as chemical vapor deposition, physical vapor deposition, the like, or combinations thereof to a thickness over the first dielectric material 301 of between about 100 nm and about 300 nm. However, any suitable materials and methods of deposition may be utilized.

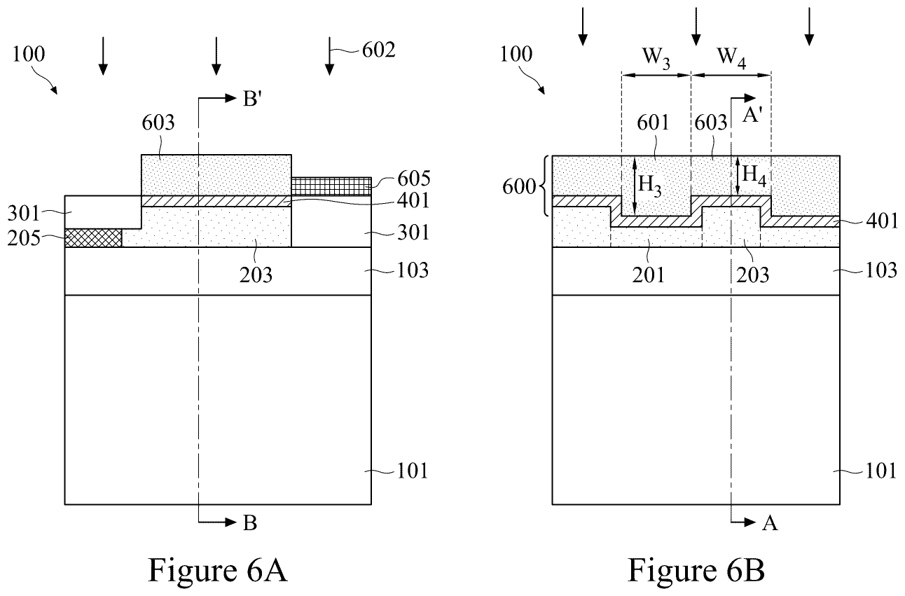

FIGS. 6A-6B illustrate a patterning and implantation of the second material 501, wherein FIG. 6B illustrates a cross-sectional view of FIG. 6A along line B-B′ and wherein FIG. 6A illustrates a cross-sectional view of FIG. 6B along line A-A′. In an embodiment the second material 501 may be patterned into the desired shape for a portion of the photonic electro-optical modulator 100. In an embodiment the second material 501 may be patterned using, e.g., one or more photolithographic masking and etching processes. However, any suitable method of patterning the second material 501 may be utilized.

In the embodiment illustrated in FIGS. 6A-6B, the second material 501 is patterned to form a second dopant region 600 that has a fourth region 601, a fifth region 603 and a sixth region 605. For example, the fourth region 601 may be patterned to have a third width W₃ of between about 100 nm and about 300 nm, such as about 500 nm, and a third height H₃ of between about 100 nm and about 300 nm. However, any suitable dimensions may be utilized.

Looking next at the fifth region 603, the fifth region 603 may be formed with a smaller thickness than the fourth region 601. In an embodiment the fifth region 603 may be formed to have a fourth width W₄ of between about 50 nm and about 400 nm and a fourth height H₄ of between about 50 nm and about 200 nm, such as about 90 nm. However, any suitable dimensions may be utilized.

Additionally, while FIG. 6B illustrates two fourth regions 601 and two fifth regions 603, this is intended to be illustrative and is not intended to be limiting upon the embodiments. Rather, any suitable number of fourth regions 601 and fifth regions 603 may be utilized. All such numbers are fully intended to be included within the scope of the embodiments.

Once the second material 501 has been patterned, a second implantation process (represented in FIGS. 6A-6B by the arrows labeled 602) may be performed in order to implant second dopants into the fourth region 601 and the fifth region 603. In an embodiment the second implantation process 602 may be two or more implantations which implant second dopants within the fourth region 601, the fifth region 603 and a sixth region 605 which may be utilized along with the first dopants (e.g., in the first region 201 and the second region 203) to form the photonic electro-optical modulator 100. As such, while the precise second dopant may be dependent at least in part on the design of the photonic electro-optical modulator 100, in some embodiments the second dopants may be an n-type dopant such as phosphorous, arsenic, antimony, combinations of these, or the like. However, any suitable dopants may be used.

In an embodiment the second dopants may be implanted into the fourth region 601 and the fifth region 603 using one of the implantations of the second implantation process 602, whereby ions of the desired second dopants are accelerated and directed towards the fourth region 601 and the fifth region 603. The ion implantation process may utilize an accelerator system to accelerate ions of the desired second dopant at a second dosage concentration. As such, while the precise dosage concentration utilized will depend at least in part on the fourth region 601 and the fifth region 603 and the second dopants used, in one embodiment the accelerator system may utilize an energy of between about 100 eV and about 600 eV along with a dosage concentration of about 1E13 atoms/cm² to about 1E15 atoms/cm². However, any suitable parameters may be utilized.

Additionally, the second dopants may be implanted perpendicular to the fourth region 601 and the fifth region 603 or else at, e.g., an angle of between about 0° and about 60°, from perpendicular to the fourth region 601 and the fifth region 603 and may be implanted at a temperature of between about −20° C. and about 100° C. However, any suitable parameters may be utilized.

In one particular embodiment the second dopants are implanted in order to form N+ regions within the patterned second material 105. As such, the second dopants may have a concentration within the fourth region 601 and the fifth region 603 of between about 1e17 cm⁻³ and about 5e18 cm⁻³. However, any suitable concentration may be utilized.

One of the implantations of the second implantation process 602 may also be used to implant the second dopants into the sixth region 605. In this embodiment the sixth region 605 may be a N++ region and, as such, comprises the second dopants at a concentration of between about 1e19 cm⁻³ and about 1e21 cm⁻³. However, any suitable concentrations may be utilized.

The second implantation process 602 may be performed by any suitable number of implantations. For example, in one embodiment two or more separate implantations may be performed in order to implant the second dopants into the fourth region 601, the fifth region 603, and the sixth region 605, or more than two implants may be utilized. In other embodiments, a single implant may be performed for the fourth region 601 and the fifth region 603 while a second implant is performed for the sixth region 605. Any suitable number of implants may be utilized, and all such implants are fully intended to be included within the scope of the embodiments.

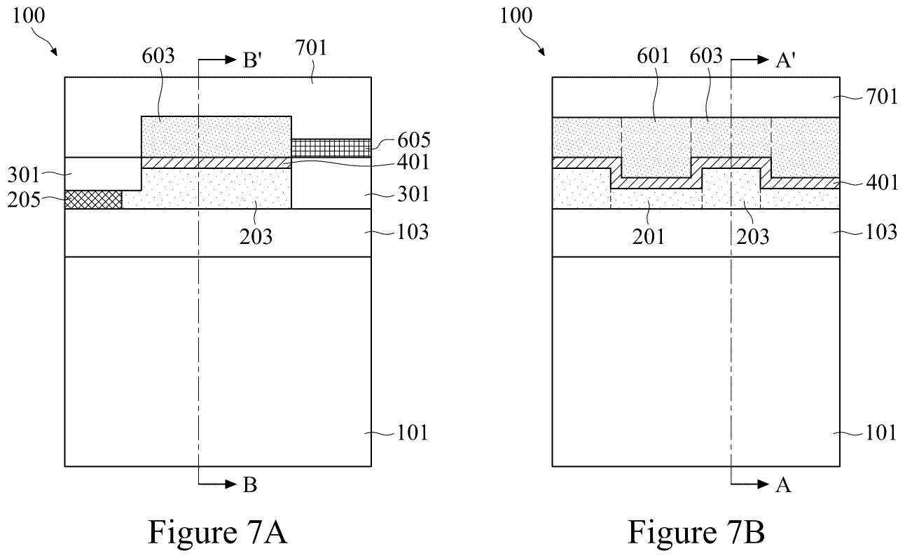

FIGS. 7A-7B illustrate a deposition of a third dielectric material 701 over the fourth region 601, the fifth region 603, and the sixth region 605, wherein FIG. 7B illustrates a cross-sectional view of FIG. 7A along line B-B′ and wherein FIG. 7A illustrates a cross-sectional view of FIG. 7B along line A-A′. In an embodiment the third dielectric material 701 may be similar to the first dielectric material 301 (e.g., an oxide material) and may be deposited using similar methods such as chemical vapor deposition. However, any suitable material and method of manufacture may be utilized.

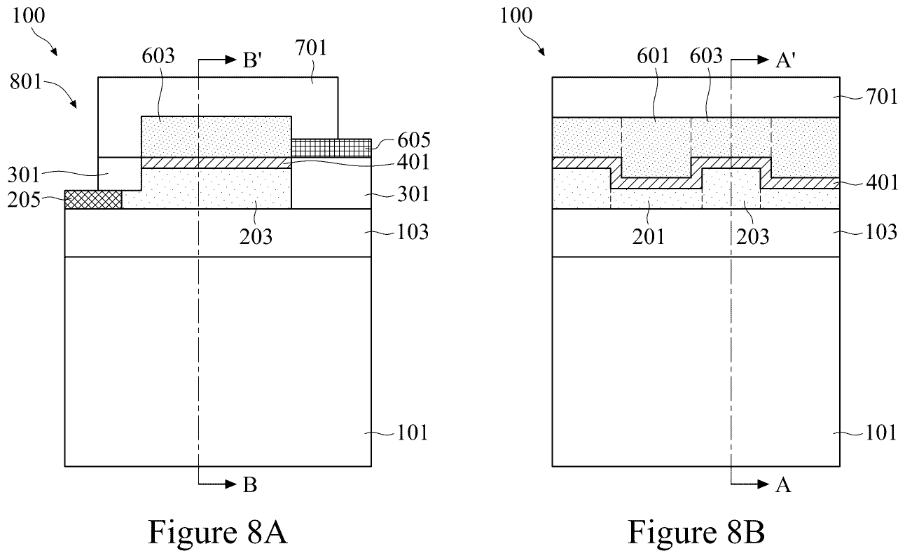

FIGS. 8A-8B illustrate a patterning of the third dielectric material 701, wherein FIG. 8B illustrates a cross-sectional view of FIG. 8A along line B-B′ and wherein FIG. 8A illustrates a cross-sectional view of FIG. 8B along line A-A′. In an embodiment the third dielectric material 701 is patterned in order to form openings 801 to the third region 205 and the sixth region 605. The openings 801 may be formed using one or more photolithographic masking and etching processes. However, any suitable methods may be used to form the openings 801.

FIGS. 9A-9B illustrate a filling of the openings 801 to form contacts 901, wherein FIG. 9B illustrates a cross-sectional view of FIG. 9A along line B-B′ and wherein FIG. 9A illustrates a cross-sectional view of FIG. 9B along line A-A′. In an embodiment the contacts 901 may be a conductive material such as Cu, W, Al, AlCu, Co, TaC, TaCN, TaSiN, Mn, Zr, TiN, Ta, TaN, Ni, Ti, TiAlN, Ru, Mo, or WN, although any suitable material, such as alloys of these, combinations of these, or the like, may be used. Additionally, the material for the contacts 901 may be deposited using a deposition process such as sputtering, chemical vapor deposition, electroplating, electroless plating, or the like, to fill and/or overfill the openings 801. Any suitable material and any suitable method of manufacturing may be utilized.

Once the material for the contacts 901 has been deposited, the material for the contacts 901 may be planarized with the third dielectric material 701. In an embodiment the material of the contacts 901 may be planarized using, e.g., a chemical mechanical polishing process, whereby etchants and abrasives are utilized along with a rotating platen in order to react and remove the excess material of the contacts 901. However, any suitable planarization process may be utilized to planarize the contacts 901.

FIG. 10 illustrates a perspective view of the photonic electro-optical modulator 100 (similar to FIG. 1A), wherein in FIG. 10 the first substrate 101, the first insulator layer 103, the first dielectric material 301, and the third dielectric material 701 have been removed for clarity. As can be seen in this view the first dopant region 200 and the second dopant region 600 (with the second dielectric material 401 between the first dopant region 200 and the second dopant region 600) have parts which are interleaved with each other along an optical transmission direction (represented in FIG. 10 by the arrow labeled 1001), which is perpendicular to a TE mode electric field direction (represented in FIG. 10 by the arrow labeled 1003). For example, one of the fourth regions 601 may extend into and between different sections of the second regions 203. Similarly, one of the second regions 203 may extend into and between different sections of the fourth regions 601.

By having these sections interleaved with each other, the photonic electro-optical modulator 100 provides a three dimensional overlap between the N+ regions and the P+ regions, allowing for a better field overlap between the carrier accumulation region and the optical field during operation in embodiments in which the photonic electro-optical modulator 100 is a capacitor phase modulator. Additionally, because the second dielectric material 401 (e.g., the gate oxide) is parallel to the main electric field component of the TE guided mode which suppresses the slot waveguide effect and improves the field confinement.

As such, by forming the photonic electro-optical modulator 100 as described, the photonic electro-optical modulator 100 has a smaller device footprint with lower capacitance than other similar devices with the same modulation efficiency. Additionally, the smaller footprint of the photonic electro-optical modulator 100 minimizes the influence of poly silicon induced scattering losses, while also improving the modulation efficiency without compromising the breakdown voltage. All of this allows the photonic electro-optical modulator 100 to have a lower operation voltage for high speed operation, such as a driving voltage of less than about 1 V for a high speed operation such as 50 G to 100 G.

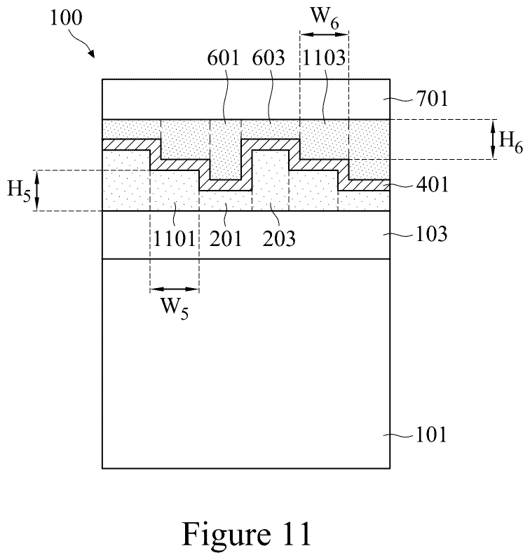

FIG. 11 illustrates another embodiment in which the first regions 201, the second regions 203, the fourth regions 601, and the fifth regions 603 are interleaved with each other. In this embodiment, however, there is also a seventh region 1101 located between the first region 201 and the second region 203 and there is also an eighth region 1103 between the fourth region 601 and the fifth region 603. Looking first at the seventh region 1101, the seventh region 1101 may be formed using the same patterning processes as used to form the first region 201 and the second region 203. However, in this embodiment the seventh region 1101 has a different thickness than either the first region 201 and the second region 203. In some embodiments the seventh region 1101 may have a fifth height H₅ of between about 100 nm and about 200 nm, and may have a fifth width W₅ of between about 50 nm and about 200 nm, such as about 500 nm. However, any suitable dimensions may be utilized.

Looking next at the eighth region 1103, the eighth region 1103 may be formed using the same patterning processes as used to form the fourth region 601 and the fifth region 603. However, in this embodiment the eighth region 1103 has a different thickness than either the fourth region 601 and the fifth region 603. In some embodiments the eighth region 1103 may have a sixth height H₆ of between about 100 nm and about 200 nm, and may have a sixth width W₆ of between about 50 nm and about 200 nm. However, any suitable dimensions may be utilized.

By forming the structure with the seventh region 1101 and the eighth region 1103, the overall structures will have a stair-step pattern with more than two thicknesses. In the particular embodiment illustrated in FIG. 11, the stair-step pattern within the first dopant region 200 will have three thicknesses, with the first region 201 having the first height H₁, the second region 203 having the second height H₂, and the seventh region 1101 having the fifth height H₅. Similarly, the stair-step pattern within the second dopant region 600 will have three thicknesses, with the fourth region 601 having the third height H₃, the fifth region 603 having the fourth height H₄, and the eighth region 1103 having the sixth height H₆. However, any suitable number of regions with any suitable number of thicknesses may be utilized.

By forming the photonic electro-optical modulator 100 with multiple heights, the footprint of the photonic electro-optical modulator 100 may be further adjusted to have the lower capacitance than other similar devices with the same modulation efficiency. As such, the smaller footprint can be obtained while still minimizing the influence of poly silicon induced scattering losses, while also improving the modulation efficiency without compromising the breakdown voltage by reducing the thickness of the second dielectric material 401. All of this allows the photonic electro-optical modulator 100 to have a lower operation voltage for high speed operation, such as a driving voltage of less than about 1 V for a high speed operation such as 50 G to 100 G.

In accordance with an embodiment, a method of manufacturing an optical device includes: forming a first layer of optical material; patterning the first layer into a stair-step pattern; depositing a dielectric material onto the stair-step pattern; and forming a second layer of optical material over the dielectric material and at least partially within the stair-step pattern. In an embodiment the forming the first layer forms a P+ region. In an embodiment the forming the second layer forms an N+ region. In an embodiment the stair-step pattern has at least two different thicknesses. In an embodiment the stair-step pattern has at least three different thicknesses. In an embodiment the first layer of optical material is part of an optical phase shifter. In an embodiment the forming the second layer of optical material forms a third region and a fourth region, the third region extending at least partially within the stair-step pattern and the fourth region having a smaller thickness than the third region.

In accordance with another embodiment, a method of manufacturing an optical device includes: forming a first layer of optical material; forming at least one recess into the first layer of optical material; depositing a dielectric material into the at least one recess; depositing a second layer of optical material over the first layer of optical material, the second layer of optical material extending at least partially into the at least one recess; and forming electrical contacts to the first layer of optical material and the second layer of optical material. In an embodiment the depositing the second layer of optical material deposits polysilicon. In an embodiment after the forming the first layer of optical material the first layer of optical material comprises silicon. In an embodiment the forming the first layer of optical material forms a p-region. In an embodiment after the depositing the second layer of optical material the second layer of optical material is an n-region. In an embodiment the method further includes implanting dopants into the second layer of optical material after the depositing the second layer of optical material. In an embodiment the forming the at least one recess forms at least two recesses with different depths.

In accordance with yet another embodiment, a optical device includes: a first optical material over a substrate; a second optical material over the substrate; and a dielectric material between the first optical material and the second optical material, wherein the first optical material and the second optical material have respective portions interleaved with each other. In an embodiment the first optical material comprises silicon and the second optical material comprises polysilicon. In an embodiment the dielectric material has a thickness of between 2 nm and 5 nm. In an embodiment the optical device further includes: a first contact in electrical connection with the first optical material; and a second contact in electrical connection with the second optical material. In an embodiment a portion of the second optical material has a thickness of about 90 nm. In an embodiment the optical device has a driving voltage of less than 1 V for an operation speed of about 50 G.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. (canceled)

2. An optical device comprising:
a first layer of optical material having a stair-step pattern;
a dielectric material on the stair-step pattern; and
a second layer of optical material over the dielectric material and at least partially within the stair-step pattern.

3. The optical device of claim 2, wherein the first layer comprises a P+ region.

4. The optical device of claim 2, wherein the stair-step pattern has at least two different thicknesses.

5. The optical device of claim 4, wherein a first thickness of the at least two different thicknesses is between about 70 nm and about 200 nm.

6. The optical device of claim 5, wherein a second thickness of the at least two different thicknesses is between about 150 nm and about 300 nm.

7. The optical device of claim 2, wherein the dielectric material comprises a metal oxide.

8. The optical device of claim 2, wherein the first layer of optical material comprises silicon nitride.

9. An optical device comprising:
a first layer of optical material;
at least one recess in the first layer of optical material;
a dielectric material in the at least one recess;
a second layer of optical material over the first layer of optical material, the second layer of optical material extending at least partially into the at least one recess; and
a first electrical contact in physical connection with the first layer of optical material; and
a second electrical contact in physical connection with the second layer of optical material.

10. The optical device of claim 9, wherein the first electrical contact has a first height and the second electrical contact has a second height less than the first height.

11. The optical device of claim 9, wherein the at least one recess has at least two different depths.

12. The optical device of claim 9, wherein the second layer of optical material comprises silicon.

13. The optical device of claim 9, wherein the recess has a width of between about 100 nm and about 400 nm.

14. The optical device of claim 9, wherein the recess is separated from a second recess by a distance of between about 100 nm and about 400 nm.

15. The optical device of claim 9, wherein the first layer is part of a capacitor phase modulator.

16. An optical device comprising:
a first optical material over a substrate;
a second optical material over the substrate; and
a dielectric material between the first optical material and the second optical material, wherein an interface between the dielectric material and the second optical material alternates from a first height above the first optical material to a second height above the first optical material.

17. The optical device of claim 16, wherein the interface alternates to a third height above the first optical material different from the first height and the second height.

18. The optical device of claim 16, wherein the first optical material is part of a capacitor phase modulator.

19. The optical device of claim 16, further comprising:
an N+ region within the second optical material; and
a P+ region within the first optical material, wherein there is a three dimensional overlap between the N+ region and the P+ region.

20. The optical device of claim 19, wherein the P+ region has a first dopant concentration of between about 1e17 cm⁻³ and about 8e18 cm⁻³.

21. The optical device of claim 20, wherein the N+ region has a second dopant concentration of between about 1e17 cm⁻³ and about 5e18 cm⁻³.
